(19) United States
(12) Patent Application Publication
(10) Pub. No.: US 2025/0308784 A1
(43) Pub. Date: Oct. 2, 2025

(54) MULTILAYER CERAMIC CAPACITOR

(71) Applicant: TAIYO YUDEN CO., LTD., Tokyo (JP)

(72) Inventor: Ayumi MATSUOKA, Takasaki-shi (JP)

(21) Appl. No.: 19/077,660

(22) Filed: Mar. 12, 2025

(30) Foreign Application Priority Data
Mar. 27, 2024 (JP) 2024-051553

(51) Int. Cl. H01G 4/12; C04B 35/468; H01G 4/008; H01G 4/012; H01G 4/30

(52) U.S. Cl. CPC H01G 4/1227; C04B 35/4682; H01G 4/008; H01G 4/012; H01G 4/30

(57) ABSTRACT

A multilayer ceramic capacitor includes an element body including dielectric layers containing a perovskite compound represented by the general formula ABO₃, and internal electrode layers, which are laminated alternately, and also including intermediate regions between the dielectric layers and the internal electrode layers. The internal electrode layers and the intermediate regions each contain copper. Further, the following relation is satisfied: 1/(0.55t+1.54)≤a≤3, where t (μm) is the thickness of each internal electrode layer, and a (atomic %) is the concentration of copper in the internal electrode layers. The multilayer ceramic capacitor is intended to have a long service life and excellent dielectric properties.

### CROSS REFERENCES TO RELATED APPLICATION

The present application claims priority to Japanese Patent Application No. 2024-051553, filed Mar. 27, 2024, the disclosure of which is incorporated herein by reference in its entirety including any and all particular combinations of the features disclosed therein.

### BACKGROUND OF THE INVENTION

### 1. Field of the Invention

The present disclosure relates to a multilayer ceramic capacitor.

### 2. Description of the Related Art

Multilayer ceramic capacitors (MLCCs) have a structure in which dielectric layers and internal electrode layers are laminated alternately. Multilayer ceramic capacitors are used in a variety of electronic devices such as mobile phones and personal computers.

In recent years, as electronic devices become more multifunctional and increase their performance, there is a demand for smaller-sized, higher-capacity multilayer ceramic capacitors. To meet such a demand, it is effective to thin dielectric layers and internal electrode layers, and to increase the laminated number of layers. However, thinning dielectric layers and internal electrode layers can reduce the electric field strength, resulting in a reduction in the insulation reliability.

In view of the above, studies have been made on a structure which makes it possible to achieve desired capacitor properties even when dielectric layers and internal electrode layers are thinned. A known structure involves forming layers, which contain a heterogeneous element, between dielectric layers and internal electrode layers to increase the interfacial resistance, thereby enhancing the insulation reliability of a multilayer ceramic capacitor. For example, Japanese Unexamined Patent Application Publication No. 2006-319205 describes a multilayer ceramic capacitor having diffusion-phase grain layers between dielectric layers and internal electrode layers, and states that insulation deterioration can be reduced and service life characteristics can be improved.

### SUMMARY OF THE INVENTION

However, depending on the construction of a multilayer ceramic capacitor, the reliability enhancing effect of a heterogeneous element cannot be fully achieved. For example, as internal electrode layers become thinner with the recent trend toward smaller and thinner capacitors, the expected service life characteristics may not be obtained, or though the goal of a long service life may be achieved, the electrostatic characteristics may be insufficient.

It is therefore an object of the present disclosure to provide a multilayer ceramic capacitor which has a long service life and excellent dielectric properties regardless of the thickness of internal electrode layers.

In one aspect, the present disclosure provides a multilayer ceramic capacitor comprising an element body including dielectric layers comprising a perovskite compound represented by the general formula ABO₃, wherein A and B represent an A-site element and a B-site element, respectively, of the perovskite structure, and internal electrode layers, which are laminated alternately, and also including intermediate regions, which are not part of the dielectric layers or the internal electrode layers, between the dielectric layers and the internal electrode layers, respectively, wherein the internal electrode layers and the intermediate regions each contain copper, and wherein the following relation is satisfied: 1/(0.55t+1.54)≤a≤3, where t (μm) is the thickness of each internal electrode layer, and a (atomic %) is the concentration of copper in the internal electrode layers.

According to the aspect of the present disclosure, a multilayer ceramic capacitor having a long service life and excellent dielectric properties can be provided.

### BRIEF DESCRIPTION OF THE DRAWINGS

FIG. 1 is a perspective view showing a multilayer ceramic capacitor according to an embodiment of the present disclosure.

FIG. 2 is a cross-sectional view taken along line A-A of FIG. 1.

FIG. 3 is a cross-sectional view taken along line B-B of FIG. 1.

FIG. 4 is an enlarged view of area C of FIG. 2.

FIGS. 5A and 5B are diagrams showing an example of the results of a TEM-EDX analysis of a multilayer ceramic capacitor.

FIG. 6 is a diagram illustrating a method for evaluating the continuity rate of internal electrode layers.

FIG. 7 is a flowchart showing a method for manufacturing a multilayer ceramic capacitor according to an embodiment.

### DESCRIPTION OF THE PREFERRED EMBODIMENTS

Embodiments of the present disclosure will now be described in detail. The present disclosure is not limited to the embodiments. It should be noted that in the following description and drawings, elements or components having substantially the same functional configurations may be given the same symbols, and a duplicate description thereof may be omitted. As necessary, the drawings show X-axis, Y-axis, and Z-axis which are mutually orthogonal. The X-axis, Y-axis, and Z-axis define a fixed coordinate system which is fixed with respect to a multilayer ceramic capacitor. When the external shape of a multilayer ceramic capacitor, which is an example of a multilayer ceramic electronic part, is roughly rectangular parallelepiped, the X-axis, Y-axis, and Z-axis can correspond to the length, width, and height of the capacitor.

### Basic Structure of Multilayer Ceramic Capacitor

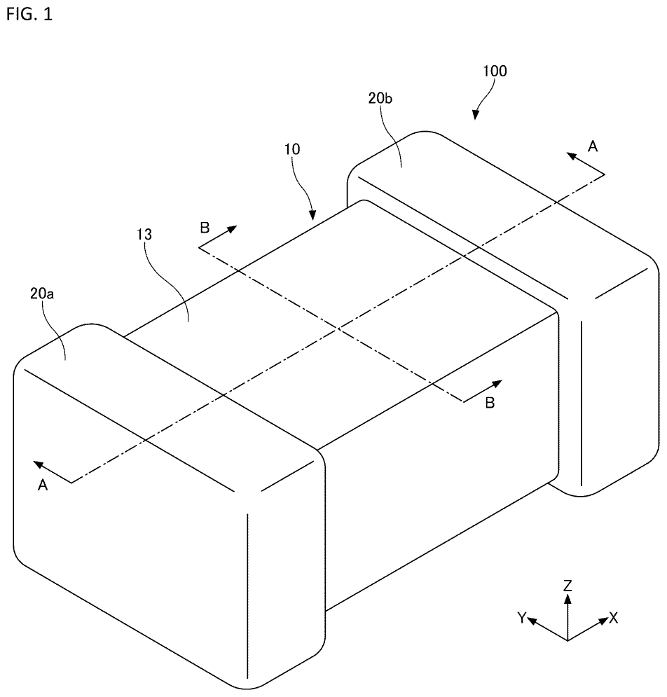

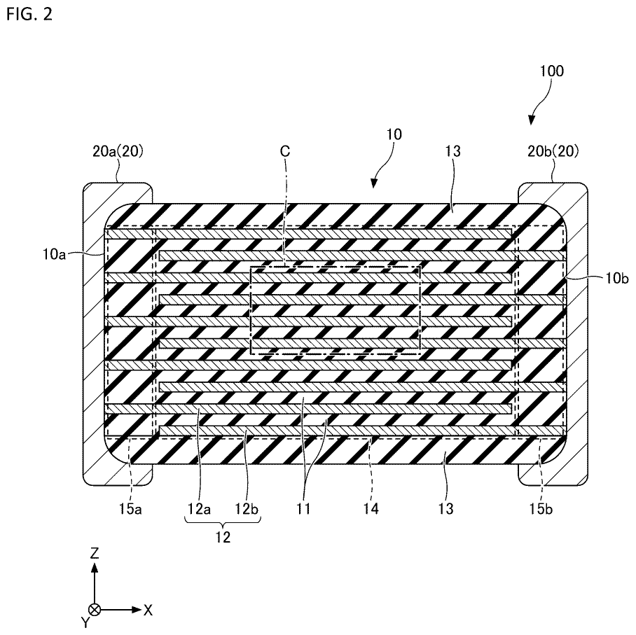

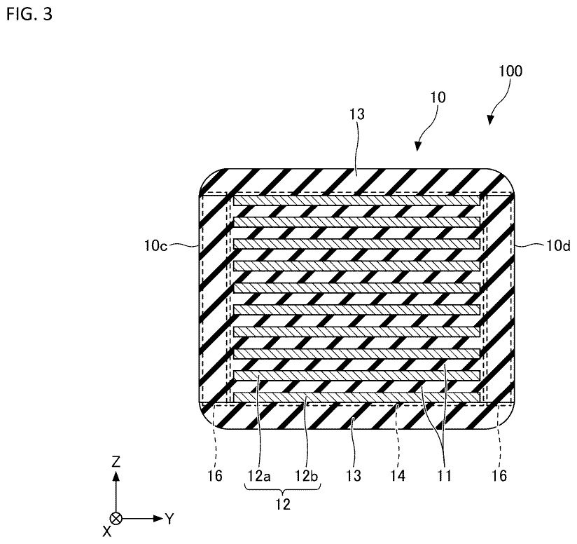

FIG. 1 is a perspective view showing a multilayer ceramic capacitor 100 according to an embodiment of the present disclosure. FIG. 2 is a cross-sectional view taken along line A-A of FIG. 1, and FIG. 3 is a cross-sectional view taken along line B-B of FIG. 1. As shown in FIGS. 1 through 3, the multilayer ceramic capacitor 100 includes an element body 10 having a roughly rectangular parallelepiped shape. In the element body 10, two opposing surfaces are referred to as an upper face and a lower face, and the four surfaces connecting the upper face and the lower face are referred to as side faces. The lower face usually corresponds to that surface of the multilayer ceramic capacitor which, when the capacitor is mounted on a circuit board, faces the circuit board, though this is not limiting of the present disclosure.

In the example shown in FIGS. 1 to 3, a first external electrode 20a and a second external electrode 20b are provided on two opposing side faces, a first side face 10a and a second side face 10b (see FIG. 2), of the element body 10. The first external electrode 20a extends from the first side face 10a to the four surfaces adjacent to the first side face 10a, and the second external electrode 20b extends from the second side face 10b to the four surfaces adjacent to the second side face 10b. Also, the first external electrode 20a and the second external electrode 20b are spaced apart from each other. The surface(s), on which the external electrodes are to be provided, is not limited to two opposing side faces; the external electrodes may be provided on any surface(s) of the element body 10.

The element body 10 has a structure in which dielectric layers 11, comprising a ceramic material which functions as a dielectric, and internal electrode layers 12 are laminated alternately. The internal electrode layers 12 include a plurality of first internal electrode layers 12a and a plurality of second internal electrode layers 12b. The first internal electrode layers 12a and the second internal electrode layers 12b are laminated alternately. One end edge of each first internal electrode layer 12a is extracted to the surface of the element body 10 on which the first external electrode 20a is provided, namely, the first side face 10a in the example of FIGS. 1 through 3. One end edge of each second internal electrode layer 12b is extracted to the surface of the element body 10 on which the second external electrode 20b is provided, namely, the second side face 10b in the example of FIGS. 1 through 3. Accordingly, the first internal electrode layers 12a and the second internal electrode layers 12b are alternately electrically connected to the first external electrode 20a and the second external electrode 20b, respectively. Thus, the multilayer ceramic capacitor 100 has a structure in which a plurality of capacitor units are laminated. It is to be noted that the number of the dielectric layers 11 and the number of the internal electrode layers 12 in FIGS. 1 through 3 are merely an example for ease of illustration only; the multilayer ceramic capacitor of this embodiment may have a larger number of laminated layers.

A first axis is herein defined as the lamination direction in which the dielectric layers 11 and the internal electrode layers 12 are laminated. As shown in FIGS. 1 through 3, when the first axis, which is the lamination direction, is a direction (Z-axis direction) along the Z-axis in the fixed coordinate system, the Z-axis is the lamination direction in which the dielectric layers 11 and the internal electrode layers 12 are laminated, and is the direction in which the internal electrode layers 12 face each other. A second axis is herein defined as an axis perpendicular to the first axis which is the lamination direction. As shown in FIGS. 1 through 3, when the second axis, perpendicular to the first axis which is the lamination direction, is a direction (X-axis direction) along the X-axis, the second axis is the direction in which the internal electrode layers 12 are extracted, and is the direction in which the first side face 10a and the second side face 10b of the element body 10 face each other, or the direction in which the first external electrode 20a and the second external electrode 20b face each other. In the example shown in FIGS. 1 through 3, the electrode extraction direction (X-axis direction) is a direction along the longitudinal direction of the element body 10. A third axis is herein defined as an axis which is perpendicular to the first axis, which is the lamination direction, and to the second axis.

As shown in FIGS. 1 through 3, when the third axis perpendicular to the first axis, which is the lamination direction, and to the second axis is a direction (Y-axis direction) along the Y axis, the third axis is an axis along the direction in which the third side face 10c and the fourth side face 10d of the four side faces of the element body 10 face each other and, in the example shown in FIGS. 1 through 3, is a direction along the width direction of the element body 10. The X-axis direction, the Y-axis direction, and the Z-axis direction are mutually orthogonal. The lamination direction is not limited to the Z direction, and may be any direction. Thus, for example, the first axis, which is the lamination direction, may be the X-axis extending in the X direction, or the Y-axis extending in the Y direction.

A figure that illustrates a particular embodiment may be used herein to illustrate a general embodiment. A description of the particular embodiment, which is given using a particular coordinate system, can be applied to the general embodiment using a general coordinate system in which the first axis denotes the lamination direction. For example, the description of the embodiment, given with reference to FIGS. 1 through 3 in which the lamination direction coincides with the Z direction, can be applied to a general embodiment using the second axis, the third axis, and the first axis in place of the X-axis, the Y-axis, and the Z-axis.

The area where the first internal electrode layers 12a, connected to the first external electrode 20a, and the second internal electrode layers 12b, connected to the second external electrode 20b, face each other is an area which produces an electrical capacitance in the multilayer ceramic capacitor 100, and is referred to as a capacitive part 14. In other words, the capacitive part 14 is an area where internal electrode layers, which are connected to the different external electrodes and located adjacent to each other via a dielectric layer, face each other.

In the capacitive part 14 where the dielectric layers 11 and the internal electrode layers 12 are laminated, the outermost portion in the lamination direction (Z-axis direction) is composed of an internal electrode layer 12. A cover layer 13 may be disposed on each of the outer surfaces of the capacitive part 14 in the lamination direction, i.e., the outer surfaces of the outermost internal electrode layers 12 in the lamination direction. The cover layers 13 comprises a ceramic material that functions as a dielectric, and may have either the same composition makeup as the dielectric layers 11 or a different composition makeup.

It should be noted that the structure of the element body 10 is not limited to that shown in FIGS. 1 through 3 as long as the first internal electrode layers 12a and the second internal electrode layers 12b are exposed on different areas of the surface of the element body 10 and are electrically connected to different external electrodes. The different areas of the surface of the element body 10 may be surface areas of opposing surfaces, surface areas of adjacent surfaces, or different surface areas of the same surface of the element body 10. As long as the different external electrodes are spaced apart from each other, they may extend from the surfaces, having the surface areas on which the first internal electrode layers 12a and the second internal electrode layers 12b are exposed, to other surfaces. Though not shown in FIGS. 1 through 3, the element body 10 may have a plurality of intermediate regions 40 between the dielectric layers 11 and the internal electrode layers 12 as will be described in detail below.

The area where the first internal electrode layers 12a, connected to the first external electrode 20a, face each other in the lamination direction without via the second internal electrode layers 12b connected to the second external electrode 20b is referred to as a first end margin 15a. The area where the second internal electrode layers 12b, connected to the second external electrode 20b, face each other in the lamination direction without via the first internal electrode layers 12a connected to the first external electrode 20a is referred to as a second end margin 15b. Each end margin is an area where the internal electrode layers connected to the same external electrode face each other in the lamination direction without via the internal electrode layers connected to a different external electrode. The first end margin 15a and the second end margin 15b are areas which do not produce an electrical capacitance.

As shown in FIG. 3, the areas adjacent to the outer peripheries of the capacitive part 14 in the Y-axis direction are each referred to as a side margin 16. The side margin 16 is an outer area adjacent to the capacitive part 14 on its side where the internal electrode layers 12 are not extracted. The side margin 16 is also an area which does not produce an electrical capacitance.

The size of the multilayer ceramic capacitor 100 is not particularly limited and may be, for example, 0.25 mm long, 0.125 mm wide, and 0.125 mm high; 0.4 mm long, 0.2 mm wide, and 0.2 mm high; 0.6 mm long, 0.3 mm wide, and 0.3 mm high; 1.0 mm long, 0.5 mm wide, and 0.5 mm high; 3.2 mm long, 1.6 mm wide, and 1.6 mm high; or 4.5 mm long, 3.2 mm wide, and 2.5 mm high. It is to be noted that the above-listed sizes of the multilayer ceramic capacitor 100 are merely examples; the multilayer ceramic capacitor 100 is not limited to such sizes. The size of the multilayer ceramic capacitor 100 may be, for example, such that length >width ≥height, width >length ≥height, height >length ≥width, or height >width ≥length. It should be noted that the multilayer ceramic capacitor 100 shown in FIGS. 1 through 3 has a length in the X-axis direction (electrode extraction direction), a width in the Y-axis direction, and a height in the Z-axis direction (lamination direction).

### Dielectric Layers

The dielectric layers 11 comprise a ceramic material as a main component, and preferably comprise a compound having a perovskite structure represented by the general formula ABO₃ (also referred to as a perovskite compound) as a main component. The dielectric layers 11 may contain the perovskite compound in an amount of, for example, 50 atomic % or more, 60 atomic % or more, 80 atomic % or more, 90 atomic % or more, or 95 atomic % or more. It should be noted that the perovskite structure may be one in which oxygen is deficient compared to the stoichiometric composition. Thus, the perovskite structure may be represented by ABO_{3-α}(0≤α≤1, α represents the amount that deviates from the stoichiometric amount) which deviates from the stoichiometric composition. As used herein, the wording “comprises a particular component as a main component” means that the particular component is contained in the largest amount by atomic percentage among all the components contained.

The perovskite compound may be one or more selected from barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr₂O₃ (0≤x≤1, 0≤y≤1, 0≤z≤1) which forms a perovskite structure. Examples of Ba_{1-x-y}CaₓSr_{y}Ti_{1-z}Zr₂O₃ include barium strontium titanate, barium calcium titanate, barium zirconate, barium titanate zirconate, calcium titanate zirconate, and barium calcium titanate zirconate.

Among the above compounds, barium titanate (BaTiO₃) is preferred. Barium titanate has excellent dielectric properties, such as high dielectric constant and low dielectric loss. Therefore, the use of barium titanate as a perovskite compound for the dielectric layers 11 can increase the capacitance of the multilayer ceramic capacitor 100. The ceramic material of the dielectric layers 11 preferably comprises barium titanate as a main component, and may be composed solely of barium titanate.

The dielectric layers 11 may contain an additive(s) other than the above-described ceramic material. Examples of the additive(s) include a simple substance or compound comprising one or more elements selected from zirconium (Zr), magnesium (Mg), manganese (Mn), molybdenum (Mo), vanadium (V), chromium (Cr), and rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)); a simple substance or compound comprising one or more elements selected from cobalt (Co), nickel (Ni), lithium (Li), boron (B), sodium (Na), potassium (K), and silicon (Si); and glass comprising an oxide containing one or more elements selected from cobalt, nickel, lithium, boron, sodium, potassium, and silicon.

It should be noted that the dielectric layers 11 may contain copper (Cu). In that case, the concentration of Cu in the dielectric layers 11 is preferably 0.1 atomic % or less from the viewpoint of ensuring the insulation properties of the dielectric.

### Internal Electrode Layers

The internal electrode layers 12 comprise a metal or an alloy as a main component. For example, the internal electrode layers 12 may comprise, as a main component, a base metal such as nickel (Ni) or tin (Sn), or an alloy containing such elements. It should be noted that the internal electrode layers 12 may comprise, as a main component, a noble metal such as platinum (Pt), palladium (Pd), silver (Ag), or gold (Au), or an alloy containing such elements. From the viewpoint of achieving excellent electrical properties and cost reduction, the internal electrode layers 12 preferably contain Ni, and may comprise Ni as a main component.

It should be noted that the main component of the first internal electrode layers 12a and the main component of the second internal electrode layers 12b may be the same or different.

Further, the internal electrode layers 12 contain Cu. When the internal electrode layers 12 comprise Ni as a main component, Cu may form an alloy with Ni. The inclusion of Cu in the internal electrode layers 12 increases the interfacial resistance between each internal electrode layer and an adjacent dielectric layer, thereby extending the service life of the MLCC.

The thickness t (mm) of each internal electrode layer 12 may preferably be 0.1 um or more and 1.5 μm or less, more preferably 0.3 μm or more and 1.0 μm or less. By making the thickness of each internal electrode layer 12 at 0.1 μm or more, its function as an internal electrode can be ensured. The thickness of each internal electrode layer 12 is preferably 1.5 μm or more in that in a multilayer ceramic capacitor of the same size, the laminated number of layers in the capacitive part 14 can be increased to increase the capacitance, that is, a smaller multilayer ceramic capacitor with the same performance can be obtained. From the viewpoint of being capable of increasing the capacitance by increasing the laminated number of layers, the thickness t (mm) of each internal electrode layer 12 is preferably, for example, not more than 0.5 μm, more preferably not more than 0.4 μm.

The thickness t of each internal electrode layer 12 can be determined, for example, based on an observation of a cross-section of the multilayer ceramic capacitor 100. In particular, the multilayer ceramic capacitor 100 is polished along the X-axis or Y-axis direction to expose a YZ or XZ plane of the capacitive part 14. The position of a plane to be exposed by polishing is preferably near the center of the capacitive part 14 in the X-axis or Y-axis direction. The exposed surface is imaged by a laser microscope or the like, and about 5 to 10 internal electrode layers 12 are selected from each of a central area, a top area, and a bottom area in the Z-axis direction, which is the lamination direction of the internal electrode layers 12, for a total of 15 to 20 internal electrode layers 12. The thicknesses (lengths in the Z-axis direction) of these internal electrode layers 12 are measured at positions corresponding to ¼, ½, and ¾ of the width of each internal electrode layer 12, and the average value can be taken as the thickness t (μm) of each internal electrode layer 12. Imaging by a laser microscope or the like may be performed separately for each of the central area, the top area, and the bottom area in the Z-axis direction which is the lamination direction of the internal electrode layers 12, or may be performed separately for each of the positions corresponding to ¼, ½, and ¾ of the width of each internal electrode layer 12.

### Intermediate Regions

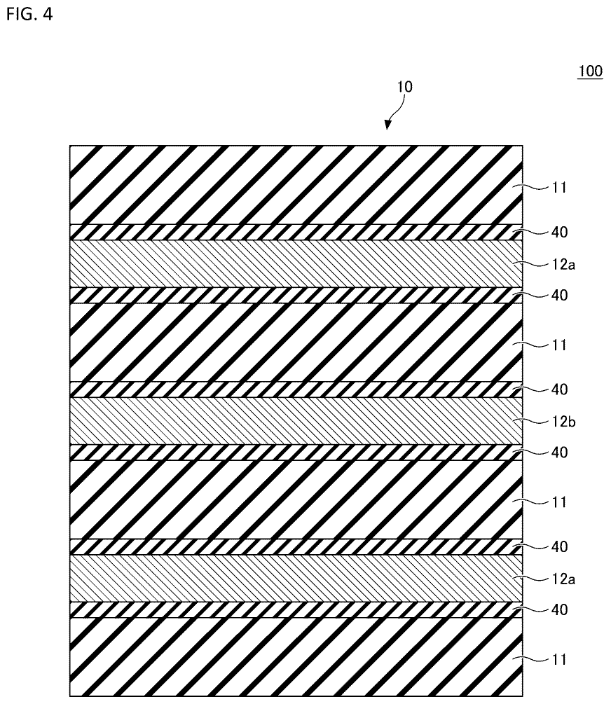

FIG. 4 is an enlarged view of area C of FIG. 2. As shown in FIG. 4, the multilayer ceramic capacitor 100 according to this embodiment has intermediate regions 40 between the dielectric layers 11 and the internal electrode layers 12. FIG. 4 is a schematic diagram which shows each intermediate region 40 as a continuous layer having a constant thickness; however, the form or shape of the intermediate regions 40 is not limited to that illustrated in FIG. 4. For example, each intermediate region 40 may be discontinuous, or may have different thicknesses at different locations. The intermediate regions 40 may be formed in the following manner. In a firing step (which will be described in detail below) of a process for manufacturing the multilayer ceramic capacitor 100, an unfired material for forming dielectric layers, which is to form the dielectric layers 11, and an unfired material for forming internal electrode layers, which is to form the internal electrode layers 12, are laminated, and the laminated body is fired. During the firing step, element segregation occurs between adjacent layers, leading to the formation of the intermediate regions 40.

The intermediate regions 40 can be checked based on an observation of a cross-section of the multilayer ceramic capacitor 100. For example, as described above for the determination of the thickness t of the internal electrode layers 12, a YZ plane or an XZ plane of the capacitive part 14 is exposed. A line analysis of the exposed surface is performed along the Z-axis direction by energy dispersive X-ray (EDX) spectroscopy using a transmission electron microscope (TEM), and a graph of the concentration distribution of each element is output. In the graph, (i) a region where the distribution range of a main component element of the internal electrode layers 12, wherein the content of the main component element deviates from normal variations in the internal electrode layers 12, overlaps with the distribution range of a main component element of the dielectric layers 11, wherein the content of the main component element deviates from normal variations in the dielectric layers 11, or (ii) a region where a concentration gradient of the main component element of the internal electrode layers 12 and a concentration gradient of the main component element of the dielectric layers 11 increase, can be determined to be an intermediate region 40. When a strict boundary is required, a region where the oxygen concentration is 5 atomic % or more, and the concentration of titanium (Ti), among the main component elements of the dielectric layers 11, is 15 atomic % or less may be determined to be an intermediate region 40.

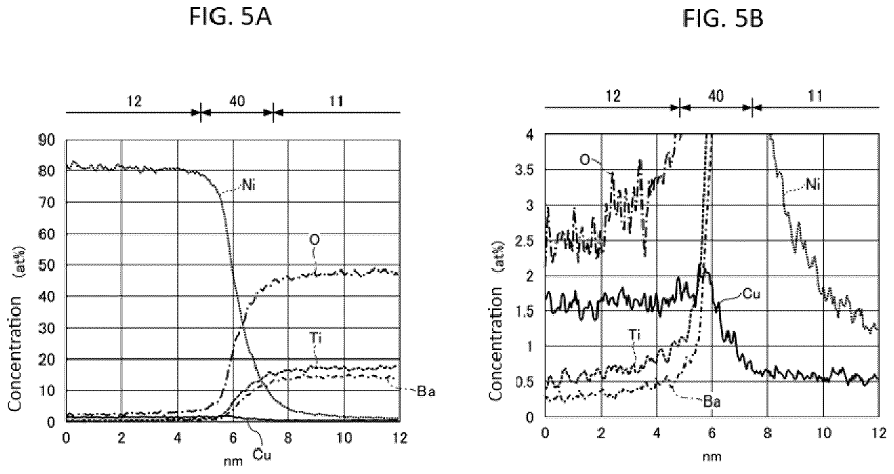

FIG. 5A shows an example of a graph of the concentration distribution obtained by a TEM-EDX analysis of an XZ plane which has been exposed by polishing the multilayer ceramic capacitor 100 of this embodiment. FIG. 5B is a part of the graph of FIG. 5A, enlarged in the ordinate direction (enlarged view in the concentration range of 0 atomic % to 4 atomic %). FIGS. 5A and 5B show the analytical results for the multilayer ceramic capacitor 100 including the dielectric layers 11 composed of barium titanate and the internal electrode layers 12 comprising nickel as a main component and containing Cu. As can be seen in FIGS. 5A and 5B, there is a region where a concentration gradient of nickel (Ni) as well as concentration gradients of oxygen (O), titanium (Ti), and barium (Ba) increase in an intermediate region 40 between a dielectric layer 11 and an internal electrode layer 12.

The intermediate regions 40 contain Cu. Cu is a heterogeneous element, i.e., an element different from a main component element(s) constituting the dielectric layers 11 and a main component element(s) constituting the internal electrode layers 12. The presence of such a heterogeneous element between a dielectric layer 11 and an internal electrode layer 12 can increase the interfacial resistance between the dielectric layer 11 and the internal electrode layer 12, making it possible to achieve high insulation reliability over a long period of time. Thus, the service life characteristics can be improved.

Cu in the intermediate regions 40 may have migrated and segregated from the internal electrode layers 12 and/or the dielectric layers 11, preferably from the internal electrode layers 12, during a firing step in the manufacture of the multilayer ceramic capacitor 100. Since Cu easily diffuses as compared to other elements, a sufficient amount of Cu can be segregated in between the internal electrode layers 12 and the dielectric layers 11 during the manufacturing process of the multilayer ceramic capacitor 100, enabling easy increase in the interfacial resistance.

### Cu Concentration

As described above, in the multilayer ceramic capacitor 100 of this embodiment,

Cu is present in the internal electrode layers 12 and the intermediate regions 40. The present inventors, through their intensive studies on the relationship between the Cu concentration and the properties of the multilayer ceramic capacitor 100, have found that when the following relation is satisfied, the multilayer ceramic capacitor 100 can have high long-term insulation reliability, i.e., high service life characteristics: a≥1/(0.55t+1.54), where t (μm) is the thickness of each internal electrode layer 12, and a (atomic %) is the concentration of Cu in the internal electrode layers 12. The present inventors have also found that when a≤3 is satisfied, the multilayer ceramic capacitor 100 can have good dielectric properties. As used herein, good dielectric properties can mean that the internal electrode layers 12 have a high continuity rate and/or a sufficient capacitance.

Thus, the multilayer ceramic capacitor 100 according to this embodiment satisfies the following relation: 1/(0.55t+1.54)≤a≤3, where t (μm) is the thickness of each internal electrode layer 12, and a (atomic %) is the concentration of Cu in the internal electrode layers 12. This feature makes it possible to ensure excellent dielectric properties while achieving a long service life, thus achieving high reliability.

It should be noted that the service life characteristics of the multilayer ceramic capacitor 100 can be evaluated based on the length of time required for the insulation resistance to decrease to a predetermined value in a high-temperature load test. For example, a highly accelerated service life test (HALT) can be used for the evaluation. In the test, a predetermined voltage, e.g. 9.0 V, is continuously applied at a predetermined temperature, e.g. at 150° C., to multilayer ceramic capacitors 100. The time required for half of the multilayer ceramic capacitors tested to exceed a leakage current threshold is taken as a 50% HALT service life value. A higher 50% HALT service life value indicates a longer life.

The concentration a (atomic %) of Cu in the internal electrode layers 12 may preferably be 2.5 or less, more preferably 2 or less, even more preferably 1.5 or less, and still more preferably 1 or less. By making the concentration a (atomic %) within the above ranges, it is possible to prevent a decrease in the continuity rate (%) due to a decrease in the melting point of the internal electrode layers 12 caused by the presence of excess Cu in the internal electrode layers 12. On the other hand, the concentration a (atomic %) may preferably be 0.2 or more, more preferably 0.3 or more, and even more preferably 0.5 or more from the viewpoint of improving the service life characteristics.

Further, the concentration b (atomic %) of Cu in the intermediate regions 40 preferably satisfies 1≤b≤4.5. The Cu concentration range may more preferably be 1.2≤b≤4, even more preferably 1.3≤b≤3, and still more preferably 1.5≤b≤2.5. When the concentration b (atomic %) of Cu in the intermediate regions 40 is 1 or more, Cu can be distributed such that it covers the internal electrode layers 12 with a sufficient area ratio. This can increase the interfacial resistance and achieve high service life characteristics. When the Cu concentration b (atomic %) is 4.5 or less, the deterioration of insulation properties due to the presence of excess Cu can be avoided, and excellent electrostatic characteristics can be obtained. In particular, when b≤2.5, a high capacitance can be ensured.

b/(0.55t+1.54) is preferably 0.48 or more and 2.5 or less. If b/(0.55t+1.54) is less than 0.48, the 50% HALT service life value will be low, which is undesirable. If b/(0.55t+1.54) is 2.5 or more, the capacitance will decrease by 10% or more, which is undesirable.

From the viewpoint of achieving high service life characteristics, b/(0.55t+1.54) is preferably 0.48 or more because the 50% HALT service life value can be made more than 1000 minutes. b/(0.55t+1.54) is more preferably 1.2 or more because the 50% HALT service life value can be made 2000 minutes or more, and is even more preferably 2.0 or more because the 50% HALT service life value can be made 3000 minutes or more.

From the viewpoint of ensuring a sufficient capacitance, b/(0.55t+1.54) may preferably be 3 or less, more preferably 2.5 or less, even more preferably 2.0 or less, still more preferably 1.5 or less, and yet more preferably 1.0 or less.

The concentration b (atomic %) of Cu in the intermediate regions 40 may be higher than the concentration a (atomic %) of Cu in the internal electrode layers 12. For example, the ratio of b to a, i.e. b/a, may preferably be not less than 1.2 and not more than 5, more preferably not less than 1.5 and not more than 3.5.

It should be noted that the concentration b (atomic %) of Cu in the intermediate regions 40 may be a value obtained by a TEM-EDX analysis of a surface of the capacitive part 14, which has been exposed by polishing, performed in the same manner as that described above for the checking of the intermediate regions 40. As used herein, the concentration b (atomic %) of Cu in an intermediate region 40 refers to the maximum Cu concentration (atomic %) in a region which is identified as an intermediate region 40 in a concentration distribution graph obtained by the TEM-EDX analysis. The concentration a (atomic %) of Cu in an internal electrode layer 12 refers to the average Cu concentration (atomic) % in an internal electrode-side region excluding the intermediate region 40 in the concentration distribution graph obtained by the TEM-EDX analysis. When a strict boundary is required, a region where the oxygen concentration is less than 5 atomic % may be determined to be a region corresponding to an internal electrode layer 12. The concentrations a and b both refer to the atomic ratio of Cu to all the elements contained in the internal electrode layers 12.

The continuity rate of the internal electrode layers 12 may preferably be 78% or more, more preferably 80% or more, even more preferably 85% or more, and still more preferably 90% or more.

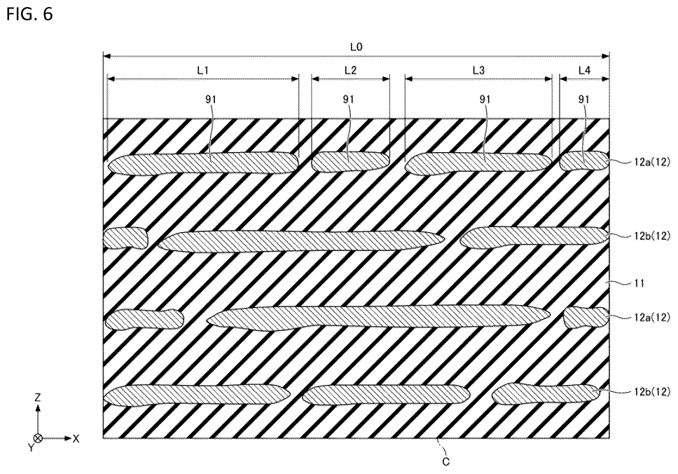

A measurement of the continuity rate of the internal electrode layers 12 can be performed on a surface of the capacitive part 14, which has been exposed by polishing, in the same manner as described above for the determination of the thickness t of each internal electrode layer 12 and for the checking of the intermediate regions 40. The exposed XZ or YZ surface is imaged by a laser microscope or the like, and about 5 to 10 internal electrode layers 12 are selected from each of a central area, a top area, and a bottom area in the Z-axis direction, which is the lamination direction of the internal electrode layers 12, for a total of 15 to 20 internal electrode layers 12. FIG. 6 shows a schematic diagram of the image. In the image, electrode portions 91, 91, . . . , which are each a continuous portion of the internal electrode layers 12, are determined e.g. from the contrast, and the length of each of the electrode portions 91, 91, . . . at the center in the Z-axis direction is measured. For example, the lengths L1, L2, . . . , Ln of the electrode portions 91, 91, . . . of one internal electrode layer 12 are measured, and the sum of the measured lengths is divided by the length L0 of the measurement area to get a value ((L1+L2+ . . . , +Ln)/L0) which can be taken as the continuity rate (%) of the one internal electrode layer 12. Further, the continuity rates of other internal electrode layers 12 in the image are calculated in the same manner, and the average value can be taken as the continuity rate (%) of the internal electrode layers 12 in the multilayer ceramic capacitor sample. The total number of internal electrode layers 12 for which the continuity rate is measured preferably includes the same number of first internal electrode layers 12a and second internal electrode layers 12b. It should be noted that an image taken by a scanning electron microscope (SEM) can also be used for the measurement of continuity rate.

### Method for Manufacturing Multilayer Ceramic Capacitor

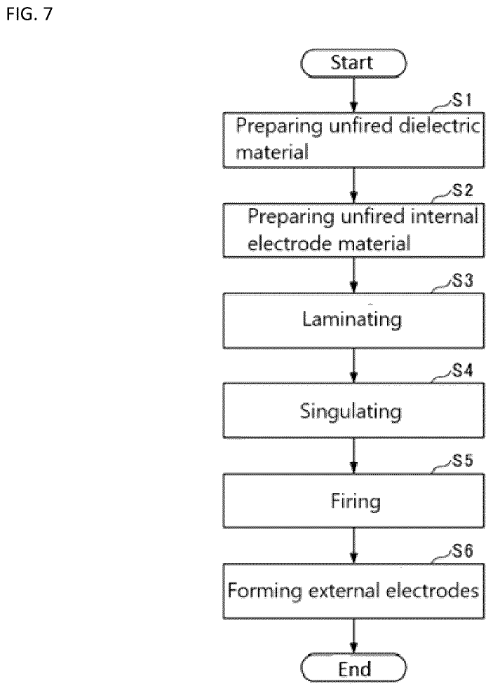

Next, a method for manufacturing the multilayer ceramic capacitor 100 will now be described. One embodiment of the present disclosure may provide a method for manufacturing a multilayer ceramic capacitor comprising an element body including dielectric layers comprising a perovskite compound represented by the general formula ABO₃, and internal electrode layers, which are laminated alternately, and also including intermediate regions between the dielectric layers and the internal electrode layers, the method comprising: a laminating step of alternately laminating an unfired dielectric material, which is to form the dielectric layers, and an unfired internal electrode material, which is to form the internal electrode layers, to obtain a laminated body; and a firing step of firing the laminated body, wherein after the firing step, the internal electrode layers and the intermediate regions each contain copper, and wherein the following relation is satisfied: 1/(0.55t+1.54)≤a≤3, where t (μm) is the thickness of each internal electrode layer, and a (atomic %) is the concentration of copper in the internal electrode layers. FIG. 7 is a flowchart illustrating the method for manufacturing the multilayer ceramic capacitor 100 according to the embodiment.

### Unfired Dielectric Material Preparation Step (S1)

In an unfired dielectric material preparation step (S1), ceramic green sheets (unfired dielectric material) which are to form the dielectric layers 11 by firing are prepared.

First, a ceramic powder for forming dielectric layers is prepared. The ceramic powder may be a powder of the ceramic material described above for the dielectric layers 11 of the multilayer ceramic capacitor 100. Thus, the ceramic powder may comprise a powder of the above-described perovskite compound represented by the general formula ABO₃, preferably a powder of barium titanate. Barium titanate can generally be obtained by reacting a titanium raw material, such as titanium dioxide, with a barium raw material such as barium carbonate. The ceramic powder, which is to become a ceramic material as a main component of the dielectric layers 11, can be synthesized by a conventional method such as a solid-phase method, a sol-gel method, or a hydrothermal method.

An additive(s) may be added to the dielectric layer-forming ceramic powder according to the intended use. The dielectric layer-forming ceramic powder is wet-mixed with or without an additive(s), dried, and pulverized. To the resulting dielectric layer-forming powder are added a binder such as a polyvinyl butyral (PVB) resin, an organic solvent such as ethanol or toluene, and a plasticizer, and the mixture is wet-mixed to prepare a dielectric layer-forming slurry. The obtained dielectric layer-forming slurry is applied to a substrate, such as a polyethylene terephthalate (PET) film, by a die coater method, a doctor blade method, or the like, followed by drying to obtain a ceramic green sheet (unfired dielectric layer material).

### Unfired Internal Electrode Material Preparation Step (S2)

In an unfired internal electrode material preparation step (S2), an unfired internal electrode material which is to form the internal electrode layers 12, i.e., the first internal electrode layers 12a and the second internal electrode layers 12b, is prepared. A metal as a main component of the unfired internal electrode material may be the same metal material as described above for the internal electrode layers 12 of the multilayer ceramic capacitor 100, for example a base metal such as Ni or Sn, or an alloy containing such elements. A noble metal such as Pt, Pd, Ag, or Au, or an alloy such elements may also be used. From the viewpoint of achieving excellent electrical properties and cost reduction, the metal material preferably contains Ni, and more preferably comprises Ni as a main component.

Cu is added to the metal material. The metal material after the addition of Cu, an organic binder, and a solvent are kneaded to obtain a metal paste (unfired internal electrode material). It should be noted that Cu may be added after preparing a metal paste from the main component metal material.

The amount of Cu in the unfired internal electrode material can be adjusted so that the following relation is satisfied: 1/(0.55t+1.54)≤a≤3, where t (μm) is the thickness of each internal electrode layer 12 after a firing step (S5), and a (atomic %) is the concentration of Cu in the internal electrode layers 12 after firing. The interfacial resistance between each dielectric layer 11 and an adjacent internal electrode layer 12 can be increased by adjusting the amount of Cu to be added so that the following relation is satisfied: a≥1/(0.55t+1.54). Therefore, high long-term insulation reliability, and thus high service life characteristics can be achieved. Further, a high continuity rate and a high capacitance can be maintained by adjusting the amount of Cu to satisfy a≤3. Thus, this embodiment makes it possible to manufacture a multilayer ceramic capacitor 100 which is excellent both in service life characteristics and in electrostatic characteristics.

In the multilayer ceramic capacitor manufacturing process of this embodiment, the amount of Cu to be added can be adjusted based on the above-described relation between the thickness t (μm) of each internal electrode layer 12 and the concentration a (atomic %) of Cu in the internal electrode layers 12. Therefore, for example, when it is intended to manufacture a multilayer ceramic capacitor with a new design in which the thickness t of each internal electrode layer 12 is changed, it is easy to adjust the amount of Cu to be added. This makes it possible to provide a highly reliable multilayer ceramic capacitor even with such a new design.

The amount of Cu in the unfired internal electrode material is preferably adjusted so that the multilayer ceramic capacitor 100 obtained after firing satisfies 0.1≤t≤1.5. Further, the amount of Cu to be added is preferably adjusted so that the multilayer ceramic capacitor 100 obtained after firing satisfies a≥0.5. Furthermore, the amount of Cu to be added is preferably adjusted so that in the multilayer ceramic capacitor 100 obtained after firing, the concentration b (atomic percent) of copper in the intermediate regions 40 satisfies 1≤b≤4.5.

It should be noted that a ceramic powder as a co-existent material can be added to the metal paste (unfired internal electrode material). While the main component of the ceramic powder is not particularly limited, it is preferably the same as that of the ceramic powder used in the unfired dielectric material preparation step (S1). When the ceramic powder is used as a co-existent material, it can be added when kneading the metal paste.

### Laminating Step (S3)

In a laminating step (S3), the metal paste obtained in the unfired internal electrode material preparation step (S2) is printed by screen printing, gravure printing, or the like on the surface of each of ceramic green sheets obtained in the unfired dielectric material preparation step (S1). In this manner, a first internal electrode pattern, which is to become a first internal electrode layer 12a, and a second internal electrode pattern, which is to become a second internal electrode layer 12b, can be placed on the surface of each ceramic green sheet. It should be noted that the method of forming an internal electrode pattern is not limited to printing; an internal electrode pattern may be formed by plating, vacuum deposition, sputtering, CVD, or the like using a mask.

The ceramic green sheets on which the metal paste has been printed are laminated such that the internal electrode layers 12 are to be alternately extracted to a pair of external electrodes 20a, 20b which will be disposed at both ends of the dielectric layers 11 in the length direction (X-axis direction). A known technique can be used for forming the laminate. For example, in order to form side margins 16 in areas in which the first internal electrode layers 12a or 12b are not extracted and which are located outside the capacitive part 14 in the Y-axis direction, an unfired dielectric material can be placed in a peripheral area of each ceramic green sheet where no internal electrode pattern of the metal paste is printed. Taking each ceramic green sheet with the metal paste printed thereon as a lamination unit, the number of lamination units can be 100 to 500.

Subsequently, cover sheets, made of an unfired cover material for forming cover layers, are laminated to the top and bottom surfaces of the laminated body composed of the ceramic green sheets having internal electrode patterns, i.e. to both surfaces of the laminated body in the lamination direction (Z-axis direction) thereby completing the laminated body. The cover sheets may be formed using a ceramic powder as a main component in the same manner as the unfired dielectric material for forming dielectric layers. Also, the cover sheets can be formed from the same material as the unfired dielectric material for forming dielectric layers. The number of laminated cover sheets may be 2 to 10 on each side.

The resulting laminated body is pressure-bonded in the lamination direction (Z-axis direction) to obtain a pressure-bonded body.

### Singulation Step (S4)

Further, the pressure-bonded body can be cut or singulated into individual pieces having a predetermined size by singulating with a dicer, laser cutting, or the like. Any appropriate existing technique can be used as a singulation method.

### Firing Step (S5)

In a firing step (S5), a singulated laminated body is fired. The firing is performed in a reducing atmosphere having a hydrogen concentration of 0.03 vol % or more and 1.0 vol % or less, preferably 0.05 vol % or more and 0.3 vol % or less. It should be noted that the composition makeup of the reducing atmosphere other than hydrogen consists of nitrogen or argon. In the firing step (S5), Cu that has been added to the unsintered material segregates or diffuses to the interfaces, forming intermediate regions 40. According to this embodiment, the following relation is satisfied: 1/(0.55t+1.54)≤a≤3, where t (μm) is the thickness of each internal electrode layer 12 after firing, and a (atomic %) is the concentration of Cu in the internal electrode layers 12 after firing. The thickness t (mm) of each internal electrode layer 12 after firing may preferably be 0.1 μm or more and 1.5 μm or less, more preferably 0.3 μm or more and 1.0 μm or less.

The firing temperature in the firing step (S5) may preferably be 1000° C. or higher and 1350° C. or lower, more preferably 1150° C. or higher and 1300° C. or lower. The firing time in the firing step (S5) may be 30 minutes or more and 2 hours or less.

### External Electrode Forming Step (S6)

In an external electrode forming step, the first external electrode 20a and the second external electrode 20b can be formed e.g. by plating, thereby completing the multilayer ceramic capacitor 100.

### EXAMPLES

The present disclosure will now be described in more detail with reference to the following examples.

### Measurement/Evaluation

### Thickness of Internal Electrode Layer

A multilayer ceramic capacitor was polished, in a direction from the external electrode 20 side toward the center (i.e., along the X-axis direction), to the center in the X-axis direction to expose a YZ plane where the dielectric layers 11 and the internal electrode layers 12 were laminated. The exposed YZ plane was imaged by a laser microscope, and about 5 internal electrode layers 12 were selected from each of a central area, a top area, and a bottom area in the Z-axis direction, which is the lamination direction of the internal electrode layers 12, for a total of 15 internal electrode layers 12. The thicknesses (μm) of these internal electrode layers 12 in the Z-axis direction were measured at positions corresponding to ¼, ½, and ¾ of the width of each internal electrode layer 12, and the average value was taken as the thickness t (μm) of each internal electrode layer 12.

### Copper Concentration

A YZ plane of a multilayer ceramic capacitor sample was exposed in the same manner as described above. A line analysis was performed along the Z-axis direction in an area around the center in the Z-axis, ranging from one internal electrode layer 12 to an adjacent dielectric layer 11, by transmission electron microscopy-energy dispersive X-ray (TEM-EDX) analysis. In a graph showing the atomic concentration distribution of each element obtained by the line analysis, a region where the oxygen concentration is less than 5 atomic % and Ni is present as a main component was regarded as the region of the internal electrode layer 12. The average Cu concentration in that region was determined as the concentration a (atomic %) of Cu (copper) in the internal electrode layer 12. Further, in the same graph obtained by the line analysis, the maximum value of the Cu concentration in a region corresponding to an intermediate region 40, which is a region where the oxygen concentration is 5 atomic % or more and the concentration of Ti, among the main component elements of the dielectric layer 11, is 15 atomic % or less, was taken as the concentration b (atomic %) of Cu (copper) in the intermediate region 40. It should be noted that the above Cu concentrations a and b are both Cu concentrations (atomic %) based on all the elements detected by the analysis, and are values excluding background noise derived from the measuring apparatus.

### Continuity Rate

A YZ plane of a multilayer ceramic capacitor was exposed in the same manner as described above. The exposed surface, which was an observation surface, was imaged by a laser microscope. 5 layers of internal electrode layers 12 were selected from each of a central area, a top area, and a bottom area in the Z-axis direction, which is the lamination direction of the internal electrode layers 12, for a total of 15 internal electrode layers 12. In the image as shown in FIG. 6, the lengths of portions 91, 91, . . . , which each extend continuously in the X-axis direction, were measured. For each of the internal electrode layers 12 (15 first internal electrode layers 12a and 15 second internal electrode layers 12b), the lengths L1, L2, . . . , Ln of the electrode portions 91, 91, . . . were summed, and the sum was divided by the length L0 of the measurement area to get a value ((L1+L2+ . . . , +Ln)/L0) which was taken as the continuity rate (%) of the internal electrode layer 12. Further, the average value was determined and taken as the continuity rate (%) of the internal electrode layers 12.

### Capacitance

A multilayer ceramic capacitor was left at 150° C. for 1 hour, and then left in normal conditions (temperature 25° C., 1 atm) for 24 hours. Thereafter, the capacitance (μF) of the capacitor was measured using an LCR meter (HP 4284A, manufactured by Keysight Technologies) under the conditions of a voltage of 0.5 V and a frequency of 1 kHz.

### Service Life Characteristics

The service life characteristics were evaluated by highly accelerated service life testing (HALT). A voltage of 9.0 V was applied to each of 20 multilayer ceramic capacitors at 150° C., and the leakage current was measured over time. The time at which 50% of the samples reached a leakage current of 2000 μA was recorded as a 50% HALT service life value. It should be noted that a capacitor with a 50% HALT service life value of 1000 minutes or more was evaluated as good.

### Production of Multilayer Ceramic Capacitor

### Example 1

A polyvinyl butyral (PVB) resin, a solvent, a plasticizer, a sintering auxiliary agent powder which is an Si compound, and an additive(s) such as a rare earth element were added to a ceramic powder of barium titanate, and the mixture was wet-mixed to prepare a ceramic slurry. The ceramic slurry was applied to a substrate film using a doctor blade to form a dielectric green sheet having a thickness of about 0.8 μm. Separately, Cu in the form of a copper oxide (CuO) powder was added to and mixed with a nickel powder to prepare a mixed powder. To the mixed powder was added a polyvinyl butyral (PVB) resin, a solvent, and a plasticizer, and the resulting mixture was kneaded to obtain a metal paste (Cu-containing Ni paste) for the production of internal electrode layers. The metal paste was then printed on the dielectric green sheet to form an internal electrode layer pattern. 500 such dielectric green sheets with the metal paste printed thereon were laminated, and a dielectric green sheet which is to become a cover layer was placed on either side of the laminated sheets in the lamination direction, thereby completing a laminated body.

After pressure-bonding the resulting laminate body, it was singulated into compact chips having a predetermined size. Further, each compact chip was debindered in an N₂ atmosphere, and then a metal paste, which was to form an underlayer of each external electrode, was applied to the chip by a dip method. Subsequently, the compact chip was placed in a firing furnace, and the temperature (firing temperature) in the furnace was raised to 1200° C. and the chip was fired for 10 minutes in an atmosphere having an H₂ concentration of 0.1 vol % and an N₂ concentration of 99.9 vol %. External electrodes were formed on the fired compact chip by plating to obtain a multilayer ceramic capacitor (MLCC) having a size of 1.0 mm×0.5 mm×0.5 mm.

For the thus-obtained multilayer ceramic capacitor, the thickness t (μm) of each internal electrode layer, the concentration of Cu (atomic %) in the internal electrode layers, and the concentration of Cu (atomic %) in the intermediate regions were measured in the above-described manner. The results are shown in Table 1.

### Examples 2 to 10 and Comparative Examples 1 to 5

Multilayer ceramic capacitors were produced in the same manner as in Example 1 except that the amount of Cu added to the metal paste for forming internal electrode layers and the thickness of the internal electrode layer pattern which was to become an internal electrode layer were changed so that the thickness t (μm) of each internal electrode layer, the concentration a (atomic %) of Cu in the internal electrode layers, and the concentration b (atomic %) of Cu in the intermediate regions in the multilayer ceramic capacitor after firing were as shown in Table 1.

It should be noted that in Comparative Example 1, Cu was not added to the metal paste for forming internal electrode layers; therefore, Cu was not detected in the internal electrode layers or the intermediate regions. In Comparative Example 2, though Cu was added to the metal paste for forming internal electrode layers, no Cu was detected in the intermediate regions.

The multilayer ceramic capacitors thus obtained were subjected to the above-described evaluations.

TABLE 1

| | Internal | | Internal | | | HALT | Internal | |
|---|---|---|---|---|---|---|---|---|
| | electrode | | electrode | Intermediate | | service | electrode | |
| | layers | | layers Cu | regions Cu | | life | layers | |
| | Thickness | | concentration | concentration | | 50% | Continuity | |
| | t | 1/ | a | b | b/ | value | rate | Capacitance |
| | (μm) | (0.55t + 1.54) | (at %) | (at %) | (0.55t + 1.54) | (min) | (%) | (μF) |
| Example | 0.3 | 0.59 | 0.92 | 1.5 | 0.88 | 1214 | 84 | 22 |
| 1 | | | | | | | | |
| Example | 0.45 | 0.56 | 0.91 | 1.5 | 0.84 | 1198 | 87 | 22 |
| 2 | | | | | | | | |
| Example | 0.5 | 0.55 | 0.88 | 1.4 | 0.77 | 1180 | 90 | 22 |
| 3 | | | | | | | | |
| Example | 0.62 | 0.53 | 0.6 | 1.5 | 0.80 | 1191 | 91 | 22 |
| 4 | | | | | | | | |
| Example | 0.62 | 0.53 | 0.9 | 2.7 | 1.44 | 2490 | 86 | 21 |
| 5 | | | | | | | | |
| Example | 0.62 | 0.53 | 2.8 | 4.3 | 2.29 | 3585 | 82 | 20 |
| 6 | | | | | | | | |
| Example | 0.9 | 0.49 | 0.91 | 2.2 | 1.08 | 1340 | 93 | 21 |
| 7 | | | | | | | | |
| Example | 1.2 | 0.46 | 0.92 | 1.4 | 0.64 | 1205 | 96 | 22 |
| 8 | | | | | | | | |
| Example | 1.4 | 0.43 | 0.89 | 1.5 | 0.65 | 1189 | 95 | 22 |
| 9 | | | | | | | | |
| Example | 1.4 | 0.43 | 0.5 | 1.1 | 0.48 | 1078 | 96 | 22 |
| 10 | | | | | | | | |
| Comp. | 0.62 | 0.53 | — | — | — | 720 | 92 | 23 |
| Example | | | | | | | | |
| 1 | | | | | | | | |
| Comp. | 0.62 | 0.53 | 0.3 | — | — | 849 | 92 | 22 |
| Example | | | | | | | | |
| 2 | | | | | | | | |
| Comp. | 0.62 | 0.53 | 0.5 | 0.8 | 0.43 | 912 | 92 | 22 |
| Example | | | | | | | | |
| 3 | | | | | | | | |
| Comp. | 0.62 | 0.53 | 3.6 | 4.9 | 2.60 | 3408 | 75 | 18 |
| Example | | | | | | | | |
| 4 | | | | | | | | |
| Comp. | 0.3 | 0.59 | 0.5 | 0.8 | 0.47 | 850 | 86 | 22 |
| Example | | | | | | | | |
| 5 | | | | | | | | |

As shown in Table 1, the multilayer ceramic capacitors of Examples 1 to 10, which satisfy 1/(0.55t+1.54)≤a≤3, had a high HALT service life, a high continuity rate, and a high capacitance. On the other hand, the multilayer ceramic capacitor of Comparative Example 1, which did not contain Cu in the internal electrode layers or the intermediate regions, the multilayer ceramic capacitor of Comparative Example 2, in which Cu was not detected in the intermediate regions, and the multilayer ceramic capacitor of Comparative Examples 3 and 5, which do not satisfy 1/(0.55t+1.54)≤a≤3, all had a low HALT service life. The multilayer ceramic capacitor of Comparative Example 4, which satisfies 1/(0.55t+1.54)≤a≤3 but does not satisfy b >1, had a high HALT service life, but had a low continuity rate and a low capacitance. Thus, the multilayer ceramic capacitor was found to have insufficient electrostatic characteristics.

While the present disclosure has been described in detail with reference to embodiments, the present disclosure is not limited to the embodiments. Changes, modifications, replacements, additions, deletions, combinations, etc. may be made to the embodiments without departing from the spirit and scope as set forth in the claims.

The following are example aspects of the present disclosure.
<1> A multilayer ceramic capacitor comprising an element body including dielectric layers comprising a perovskite compound represented by the general formula ABO₃, and internal electrode layers, which are laminated alternately, and also including intermediate regions between the dielectric layers and the internal electrode layers, wherein the internal electrode layers and the intermediate regions each contain copper, and wherein the following relation is satisfied: 1/(0.55t+1.54)≤a≤3, where t (μm) is the thickness of each internal electrode layer, and a (atomic %) is the concentration of copper in the internal electrode layers.
<2> The multilayer ceramic capacitor according to <1>, further satisfying 0.1≤t≤1.5.
<3> The multilayer ceramic capacitor according to <1> or <2>, further satisfying a≥0.5.
<4> The multilayer ceramic capacitor according to <1> or <2>, further satisfying 1≤b≤4.5, where b (atomic %) is the concentration of copper in the intermediate regions.
<5> The multilayer ceramic capacitor according to <1> or <2>, further satisfying 0.48≤b/(0.55t+1.54)<2.5, where b (atomic %) is the concentration of copper in the intermediate regions.
<6> The multilayer ceramic capacitor according to <1> or <2>, where the internal electrode layers contain nickel.
<7> The multilayer ceramic capacitor according to <1> or <2>, wherein the perovskite compound represented by the general formula ABO₃ comprises barium titanate.

In this disclosure, in some embodiments, the material/composition constituting dielectric layers, internal electrode layers, side margins, end margins, intermediate regions, and perovskite structures may consist of required/explicitly indicated elements described in the present disclosure; however, “consisting of” does not exclude additional components that are known equivalents to the elements and/or unrelated components such as impurities ordinarily associated with the elements. Also, in some embodiments, the term “main component” refers to “primary, majority, or predominant component in terms of quantity or quality by atomic percentage or by mass depending on the component at issue, and the term “mainly composed of” refers to “primarily, mostly, or predominantly composed of” in terms of quantity or quality. Further, in some embodiments which are silent as to known components used in this technology field, the known components can explicitly be excluded from the embodiments. Also, in some embodiments, any two numbers of a variable can constitute a workable range of the variable as the workable range can be determined based on routine work, and any ranges indicated may include or exclude the endpoints. Additionally, any values of variables indicated (regardless of whether or not they are indicated with “about”) may refer to precise values or approximate/rounded values and include equivalents, and may refer to average, median, representative, majority, etc. in some embodiments. In this disclosure, “a” may refer to a species or a genus including multiple species, while a plural may not exclude singular according to the context. Further, “the disclosure” or “the present disclosure” may refer collectively to at least one of the embodiments or examples explicitly or inherently disclosed herein. Also, in some embodiments, any one or more of the disclosed elements or components as options can be exclusively selected or can expressly be excluded, depending on the target piezoelectric ceramic to be manufactured, its target properties, etc., and/or for practical reasons, operational reasons, etc. Additionally, in the present disclosure where conditions and/or structures are not specified, a skilled artisan in the art can readily provide such conditions and/or structures, in view of the present disclosure, as a matter of routine experimentation, etc.

What is claimed:

1. A multilayer ceramic capacitor comprising:
an element body including dielectric layers comprising a perovskite compound represented by a general formula ABO₃, wherein A and B represent an A-site element and a B-site element, respectively, of the perovskite structure, and internal electrode layers, which are laminated alternately,
wherein the element body includes intermediate regions, which are not part of the dielectric layers or the internal electrode layers, between the dielectric layers and the internal electrode layers, respectively, wherein the internal electrode layers and the intermediate regions each contain copper, and wherein the following relation is satisfied:
$$1 / ( 0.55 t + 1.54 ) \leq a \leq 3 ,$$
where t (μm) is a thickness of each internal electrode layer, and a (atomic %) is a concentration of copper in the internal electrode layers.

2. The multilayer ceramic capacitor according to claim 1, further satisfying 0.1≤t≤1.5.

3. The multilayer ceramic capacitor according to claim 1, further satisfying a≥0.5.

4. The multilayer ceramic capacitor according to claim 2, further satisfying a≥0.5.

5. The multilayer ceramic capacitor according to claim 1, further satisfying 1≤b≤4.5, where b (atomic %) is a concentration of copper in the intermediate regions.

6. The multilayer ceramic capacitor according to claim 2, further satisfying 1≤b≤4.5, where b (atomic %) is a concentration of copper in the intermediate regions.

7. The multilayer ceramic capacitor according to claim 1, further satisfying 0.48≤b/(0.55t+1.54)<2.5, where b (atomic %) is a concentration of copper in the intermediate regions.

8. The multilayer ceramic capacitor according to claim 2, further satisfying 0.48≤b/(0.55t+1.54)<2.5, where b (atomic %) is a concentration of copper in the intermediate regions.

9. The multilayer ceramic capacitor according to claim 1, where the internal electrode layers contain nickel.

10. The multilayer ceramic capacitor according to claim 2, where the internal electrode layers contain nickel.

11. The multilayer ceramic capacitor according to claim 1, wherein the perovskite compound represented by the general formula ABO₃ comprises barium titanate.

12. The multilayer ceramic capacitor according to claim 2, wherein the perovskite compound represented by the general formula ABO₃ comprises barium titanate.
